(19) United States
(12) Patent Application Publication
(10) Pub. No.: US 2020/0279503 A1
(43) Pub. Date: Sep. 3, 2020

(54) Advancing Predicted Feedback for Improved Motor Control

(71) Applicant: President and Fellows of Harvard College, Cambridge, MA (US)

(72) Inventors: Maurice Smith, Somerville, MA (US); Rishi Singh, Cambridge, MA (US)

(73) Assignee: President and Fellows of Harvard College, Cambridge, MA (US)

(21) Appl. No.: 16/753,327

(22) PCT Filed: Nov. 10, 2018
(86) PCT No.: PCT/US18/60223

§ 371 Date: Apr. 2, 2020

Related U.S. Application Data
(60) Provisional application No. 62/584,189, filed on Nov. 10, 2017.

(51) Int. Cl. G09B 19/00; A63B 69/00; G06T 7/246; G06T 7/70; A63B 71/06

(52) U.S. Cl. CPC G09B 19/0038; A63B 69/0071; G06T 7/246; G06T 7/70; A63B 71/0622; A63B 2071/0625; G06T 2207/30241; G06T 2207/10016; A63B 2220/807; A63B 2220/05; A63B 2071/0694; G06T 2207/30224

(57) ABSTRACT

Predicted feedback for improved motor training is advanced by detecting a trajectory and velocity of an object launched from a launch point by a human via a plurality of time-sequenced images from a plurality of cameras positioned at different angles relative to the launched object. From the images, an extrapolated pathway of the object toward a target is projected; and an evaluation is made as to whether the object, when following the extrapolated pathway, is projected to land within or pass through the target. A communication is then made to the human as to whether the object is projected to land within or pass through the target, wherein the communication occurs after launch yet substantially before the launched object would reach the target or a location at a distance from the launch point that matches the distance from the launch point to the target.

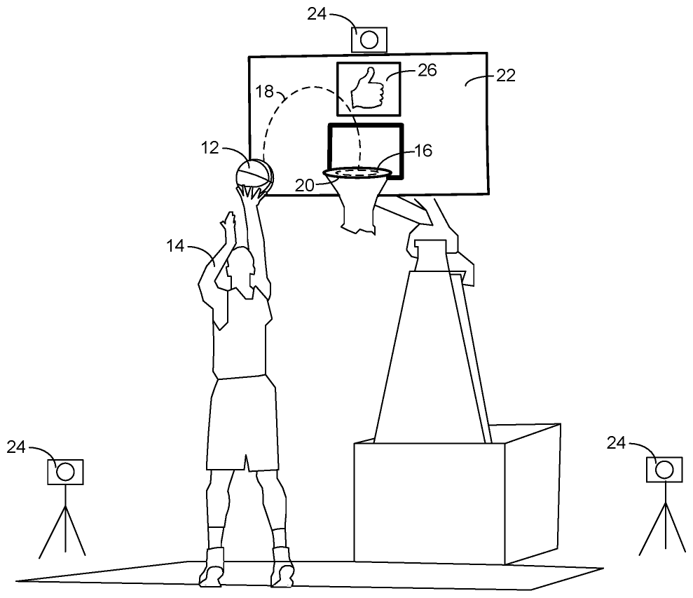

### BACKGROUND

Feedback is known to drive human motor learning, to improve the movements we make and to allow us to adapt to changing conditions. This feedback often comes in sync with movement, such as when reaching out to grasp an object.

But for many movements, the critical feedback about the final outcome or about the success of that outcome is delayed in time. For example, in bowling, a player often waits ˜2-3 seconds after letting go of the ball to see which pins the ball knocks over. In another example, a basketball player may need to wait about a second after shooting a free throw to ascertain whether his or her shot, e.g., ultimately passes through the hoop or bounces off the rim and away.

Despite dramatic increases in the intensity and quality of coaching during the last several decades in professional and college basketball, there has been essentially no improvement in shooting accuracy. For field-goal shooting, this may result, in part, from improved defensive play. However, it's striking that for free throw shooting, which is unchallenged and which occurs under predictable conditions, league-wide free-throw success averages have been virtually unchanged over the last 40+ years at about 75% free-throw success for professional players in the NBA and at about 70% free-throw success for college players in the National Collegiate Athletic Association (NCAA). The corollary substantial rate of failure (i.e., high frequency of missed free throws) suggests that even professional coaching staffs are unable to effectively coach shooting, even though the benefits to individual players and their teams from improved shooting would be substantial.

There are 26 million Americans who play basketball according to a 2012 study, making basketball the most popular sport in the United States. Basketball also is popular in many other countries worldwide. Shooting accuracy is one of the most important parts of the game, and it is a key distinguishing feature among players. Many players at all levels are interested in improving their shooting ability; and players and teams would, therefore, be expected to invest in a system that could help them achieve improved shooting ability. Similar circumstances likewise apply to other sports and activities.

### SUMMARY

The systems and methods disclosed herein can improve human motor training in movements that rely on delayed feedback by advancing this feedback in time using sensors and computer models to accurately forecast the final outcome for each movement.

A method and system for advancing predicted feedback for improved motor training are described herein, where various embodiments of the method and system may include some or all of the elements, features and steps described below.

A method for advancing predicted feedback for improved motor training includes detecting a trajectory and velocity of an object launched from a launch point by a human via a plurality of time-sequenced images from at least two cameras positioned at different angles relative to the launched object. From the images, an extrapolated pathway of the object toward a target is projected (forecast). An evaluation is then made as to whether the object, when following the extrapolated pathway, is projected to either land within or pass through the target. An indication as to whether the object is projected either to land within or pass through the target is communicated to the user after launch yet substantially before the launched object would reach the target or a location at a distance from the launch point that matches the distance from the launch point to the target, thereby providing “advanced feedback” as to the forecast outcome.

In particular embodiments, the object is a ball, such as a basketball; and the target can be, e.g., an area within a basketball hoop, which will indicate whether the ball is expected to pass through the hoop. In this context, a projection (forecast) of the object (ball) landing within or passing through the target is only provided (a) if the object is projected to not bounce off a backboard attached to the hoop or a rim that forms the hoop or (b) if the object is projected to bounce a limited number of times off the backboard or rim. In particular embodiments, the communication to the human is a visual communication projected on or through a backboard attached to the basketball hoop.

In additional embodiments, the communication to the human occurs within 200 milliseconds, or even within 100 milliseconds, after launch. The communication can be visual or auditory.

The communication can communicate a miss by providing a vector indication of divergence from the target when the object is projected to land or pass outside the target.

In particular embodiments, the spin of the launched object is also detected from the images; and at least one of the following factors: gravity, air-resistance, and object spin is accounted for in projecting the extrapolated pathway of the object.

The camera images of the object can be calibrated with images of calibration patterns and, via that calibration, the position of the object can be detected with sub-mm precision.

A first of the cameras can capture side images of the launched object from a position horizontal to the launched object, and a second of the cameras can capture top-down images of the launched object from a position above the launched object.

A system for advancing predicted feedback for improved motor training can include a plurality of cameras for generating time-sequenced digital photographs of an object launched from a launch point by a human; a computer processor in digital communication with the cameras and configured to receive time-sequenced digital image from the cameras; a computer-readable storage device in digital communication with the computer processor; and a communication device for communicating with the human.

The computer-readable storage device stores software code for: (a) detecting images of the object in the photographs; (b) determining a trajectory and velocity of the object from the images; (c) from the determined trajectory and velocity of the object, projecting whether the object will follow a pathway that will allow the object to land within or pass through a target; and (d) generating a communication signal to indicate whether the object is projected to land within or pass through the target.

The communication device is in digital communication (e.g., coupled via conductive wires or optical fibers or wirelessly, for example, via wifi or Bluetooth connections) with the computer processor and is configured to receive the communication signal and to respond to the communication signal by communicating to the human whether the object is projected to land within or pass through the target. The system is configured to communicate to the human whether the object is projected to land within or pass through the target after the human launches the object yet substantially before the object would reach the target or a location at a distance from the launch point that matches the distance from the launch point to the target.

In many ball sports, the critical feedback about the final outcome of, e.g., a throw or hit and the success of that outcome are delayed in time (e.g., in baseball, soccer, golf, bowling, basketball, and football). Advancing the delayed feedback inherent in the different skills required by each of these sports, such as shooting in basketball, throwing in football, throwing or hitting in baseball, kicking in soccer, or putting or driving in golf may involve the use of different measurements and different predictive models suited to the particular task. Implementing this advanced feedback in a training paradigm can benefit players and teams of all levels.

### BRIEF DESCRIPTION OF THE DRAWINGS

The FIGURE is an illustration of a human 14 shooting a basketball 12 at a basketball hoop 20 in a free-throw attempt using a system for advancing predictive feedback using cameras 24 and a communication device 26 (in this case, in the form of an electronic display).

### DETAILED DESCRIPTION

The foregoing and other features and advantages of various aspects of the invention(s) will be apparent from the following, more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise herein defined, used or characterized, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular shape is referenced, the shape is intended to include imperfect variations from ideal shapes, e.g., due to manufacturing tolerances. Processes, procedures and phenomena described below can occur at ambient pressure (e.g., about 50-120 kPa—for example, about 90-110 kPa) and temperature (e.g., −20 to 50° C.—for example, about 10-35° C.) unless otherwise specified.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Spatially relative terms, such as “above,” “below,” “left,” “right,” “in front,” “behind,” and the like, may be used herein for ease of description to describe the relationship of one element to another element, as illustrated in any figures. It will be understood that the spatially relative terms, as well as the illustrated configurations, are intended to encompass different orientations of the apparatus in use or operation in addition to the orientations described herein and depicted in figures. For example, if the apparatus is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly. The term, “about,” means within ±10% of the value recited. In addition, where a range of values is provided, each subrange and each individual value between the upper and lower ends of the range is contemplated and therefore disclosed.

Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified.

The terminology used herein is for the purpose of describing particular embodiments and is not intended to be limiting of exemplary embodiments. As used herein, singular forms, such as “a” and “an,” are intended to include the plural forms as well, unless the context indicates otherwise. Additionally, the terms, “includes,” “including,” “comprises” and “comprising,” specify the presence of the stated elements or steps but do not preclude the presence or addition of one or more other elements or steps.

Additionally, the various components identified herein can be provided in an assembled and finished form; or some or all of the components can be packaged together and marketed as a kit with instructions (e.g., in written, video or audio form) for assembly and/or modification by a customer to produce a finished product/system.

In one embodiment, the methodology of this disclosure is implemented in a training system based on advancing predicted feedback for basketball free throws to improve motor training. For example, a shooter 14 can receive feedback indicating whether a shot will be a make or miss (i.e., whether the basketball 12 will pass through the hoop 20) as soon as or very shortly after the ball 12 leaves his or her hand, as shown in the FIGURE. Where the shooter 14 is shooting a free throw, the shooter 14 stands behind a line that is typically 15 feet from the front plane of a backboard 22 to which a roughly circular hoop 20 is attached; and the hoop 20 is typically positioned with the top plane of the rim 10 feet above the floor and oriented parallel to the floor.

The trajectory and velocity of a launched object 12 [e.g., a ball, puck, birdie, spinning top (in the game of skittles), etc.] is determined by first precisely measuring the position and velocity of the object 12 immediately after it is launched from a launch point (e.g., when and where a ball leaves a shooter's hand) using an array of at least two digital cameras 24. For example, a plurality of digital photographs are taken by each camera 24 over a temporal sequence. The image of the object 12 can be identified via standard machine vision technology in each photograph, and a two- or three-dimensional trajectory is determined by tracking the vector position changes of the image of the object 12 relative to fixed background structures along multiple axes over time. Similarly, velocity of the object 12 is determined by dividing the difference between the positions of the images of the objects by the time between when the images were taken. A projected pathway 18 of the object 12 can then be calculated based on the initial trajectory and velocity of the object 12 and a model for projectile motion that may also incorporate additional real-world factors, such as gravity, air-resistance, spin, friction, etc., which can also be figured into the calculation to improve the accuracy of the projected pathway. The model for projectile motion can be refined, e.g., via iterative trial, observation, and refinement until the forecasts are found to be, e.g., at least 95% accurate in terms of correctly forecasting whether or not a shot basketball 12 will actually pass through the hoop 20.

Extremely accurate measurements are advantageous, as small inaccuracies in, e.g., the initial velocity measurement extrapolate to much larger prediction errors when the object 12 nears its target 16. Feedback about the projected (predicted) future flight pathway 18 of the object 12 can then be provided to the human 14 (e.g., to the basketball free-throw shooter); importantly, this feedback is communicated to the human 14 after launch (e.g., after a ball 12 leaves the shooter's hand) yet substantially before the launched object 12 would reach the target 16 (e.g., an area inside the hoop 20 wherein the ball will not hit the rim and bounce away from the basketball hoop 20) or a location at a distance from the launch point that matches the distance from the launch point to the target (if the ball 12 is following a pathway 18 that will lead to a “miss,” wherein the ball does not pass through the hoop 20).

In particular embodiments, this feedback is communicated to the human 14 50-200 milliseconds (or, in more-particular embodiments, 50-100 ms) after the object 12 (here, a ball) is released, essentially eliminating the typical delay of ˜1 second in the context of basketball free-throw shooting. In this context, the feedback can be an indication of success or failure (i.e., make or miss) or can be an indication of the difference (i.e., error) in distance and/or direction between the predicted ball position and the ideal ball position when it reaches the rim.

In a particular embodiment, two or three digital cameras 24 simultaneously take digital photographs of the ball 12 immediately after it is released by the shooter 14. Those digital photographs are then subject to computer processing. In particular embodiments, the digital cameras 24 communicate the digitized data associated with the photographs to a computer for processing. The operations and structure of the computer are described, below, in the section, entitled, “Computerized Implementation.” The computer then digitally transmits instructions to a communication device 22 (e.g., a speaker, a display, or a video projector) for communicating the forecast feedback to the human 14.

The computer first detects the position of the image of the ball 12 in each photograph. The pixel locations from each photograph are then adjusted to correct for lens distortions and triangulated to estimate the 3-D location of the ball 12 via high-precision intrinsic and stereo calibrations, respectively, which are constructed before any ball measurements are taken.

Using these 3-D ball-location estimates from two successive frames in each camera, we estimate the initial position and velocity of the ball 12. Using this estimate of the ball's initial state and a model of projectile motion for the ball 12 , we predict the future trajectory of the ball 12; and a machine-learning model is then used to correct for remaining inaccuracies and/or classify the shot as a make or miss.

After the 50-100 milliseconds required for detection, triangulation and prediction, visual feedback (via, e.g., a digital display) or auditory feedback (e.g., words or sounds, such as tones, “dings,” or buzzes, from an electronic speaker) is provided by a communication device 26 to the shooter to communicate the forecasted outcome of the shot. In a particular embodiment in the context of shooting a basketball, the feedback is communicated by projecting a visual indication (e.g., printed words, arrows, colors, symbols, a simulated representation of ball 12 and hoop 20 positioning, etc.) of whether the outcome of the shot is forecast to be a “miss” or a “make” onto or through the backboard to which the hoop is attached to thereby visibly communicate the feedback squarely within the shooter's field of view, as shown in the FIGURE.

In one exemplification, the cameras 24 were obtained from FLIR Integrated Imaging Systems (formerly Point Grey). The cameras 24 were wide-angle and designed for capturing the visible-light spectrum with a 2-6 megapixel resolution. The cameras 24 further employed USB 3.0 data transfer and an adjustable shutter, gain, and frame-rate run at 23 frames/second (43 milliseconds between each captured frame).

The individual cameras 24 were intrinsically calibrated, wherein distortion of images due to lens curvature and sensor-lens misalignment were modeled via the standard Brown-Conrady model [see Brown, Duane C., “Decentering distortion of lenses,” Photogrammetric Engineering, 32 (3): 444-462, 1966; Conrady, Alexander Eugen, “Decentred Lens-Systems,” Monthly Notices of the Royal Astronomical Society, 79 (1919): 384-390; and Z. Zhang, “A flexible new technique for camera calibration,” IEEE Transactions on Pattern Analysis and Machine Intelligence, 22(11):1330-1334, 2000], using the standard method from Zhang (cited above) to determine calibration parameters via images of checkerboards.

Standard optimization of intrinsic camera parameters was performed using the open-source Camera Calibration Toolbox developed by Jean-Yves Bouguet at California Institute of Technology (CalTech). The sub-millimeter precision for estimating position is achieved using high-precision calibration checkerboards printed on matte-finish plastic, glass-mounted and reinforced for high bending-stiffness. Blurry images of checkerboard due to the distant focus of cameras on the ball are compensated for by a method for localization of checkerboard cornerpoints immune to blur, using the rotationally-symmetric appearance of cornerpoints to estimate image locations. Extraction of fine geometric deviations away from the perfect flat grid of checkerboards via gradient-descent further improves intrinsic calibration.

Stereo calibration of two cameras 24 is used to estimate the relative position and view of a second camera with respect to a first camera via the corresponding images of a checkerboard. Each camera has a different viewing angle of the shot. While the first camera views the shot from the side of the shooter 14, parallel to the floor; the second camera views the shot from above the shooter 14, looking down at the ball 12 with an angle ˜45°. The cameras 24 have a shared scan volume of ˜10 m³. The large scan volume and disparate view of cameras 24 make it difficult to span the full view of each camera with a single checkerboard. To fully span across images from both cameras simultaneously, a long and skinny checkerboard is mounted on an 8-foot aluminum bar; and a separate glass-mounted checkerboard with large, more-visible squares is used for stereo calibration only. The geometry of these separate stereo-calibration-only checkerboards is extracted for higher precision.

The image of the ball 12 is detected by localizing the image of the ball in pixel coordinates in the photographs from each camera with sub-pixel accuracy. Using a brightly colored ball contrasted against a dark background with sufficient lighting enables the system to more readily detect the edges of the image of the ball with high fidelity. The brightness-based centroid of the image is calculated to determine the gross position of ball; and multiple iterations are performed with progressively smaller windows to decrease noise-sensitivity. Detection of ball position is fine-tuned by sensing the location of the edge of the ball image amidst pixel noise in the photograph, which also yields an accurate estimate of ball edges despite warping due to lens distortions. The ball location is undistorted via intrinsic calibration parameters, wherein the north, south, east and west edges of the image of the ball are individually undistorted to account for a non-linearity of distortion across the ball-image area.

The initial state of the ball is estimated and the ball path is predicted via a model of projectile motion. Specifically, in this embodiment, the cameras take two successive images of the ball in synchrony after release (the cameras are synchronized by an external trigger signal—currently at 23 Hz). The corresponding locations of the image of the ball obtained in pixels from photographs from each camera are converted to estimates of the real-world position of the ball in meters via stereo calibration parameters. The initial velocity of the ball is estimated as the change in the position of the image of the ball over two successive measurements divided by the time between measurements (currently 43 milliseconds). The initial position of the ball is estimated as the mean position of the image of the ball across the two measurements.

Using a physics-based model of projectile motion that includes the effects of gravity and quadratic air drag on the ball's flight, the future flight trajectory of the ball 12 until it would make contact with the rim 20 or backboard 22 (or miss them completely) for each shot is forecast; and from that forecast flight, a prediction is made as to whether the shot will be a make or miss.

### Computer Implementation:

A computer, operating as a system controller, can include a logic device, such as a microprocessor, microcontroller, programmable logic device or other suitable digital circuitry for executing control algorithms; and the systems and methods of this disclosure can be implemented in a computing system environment. Examples of well-known computing system environments and components thereof that may be suitable for use with the systems and methods include, but are not limited to, personal computers, server computers, hand-held or laptop devices, tablet devices, smart phones, multiprocessor systems, microprocessor-based systems, set top boxes, programmable consumer electronics, network PCs, minicomputers, mainframe computers, distributed computing environments that include any of the above systems or devices, and the like. Typical computing system environments and their operations and components are described in many existing patents (e.g., U.S. Pat. No. 7,191,467, owned by Microsoft Corp.).

The methods may be carried out via non-transitory computer-executable instructions, such as program modules. Generally, program modules include routines, programs, objects, components, data structures, and so forth, that perform particular tasks or that implement particular types of data. The methods may also be practiced in distributed computing environments where tasks are performed by remote processing devices that are linked through a communications network. In a distributed computing environment, program modules may be located in both local and remote computer storage media including memory storage devices.

The processes and functions described herein can be non-transitorially stored in the form of software instructions in the computer. Components of the computer may include, but are not limited to, a computer processor, a computer storage medium serving as memory, and a system bus that couples various system components including the memory to the computer processor. The system bus can be of any of several types of bus structures including a memory bus or memory controller, a peripheral bus, and a local bus using any of a variety of bus architectures.

The computer typically includes one or more of a variety of computer-readable media accessible by the processor and including both volatile and nonvolatile media and removable and non-removable media. By way of example, computer-readable media can comprise computer-storage media and communication media.

The computer storage media can store the software and data in a non-transitory state and includes both volatile and nonvolatile, removable and non-removable media implemented in any method or technology for storage of software and data, such as computer-readable instructions, data structures, program modules or other data. Computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can accessed and executed by the processor.

The memory includes computer-storage media in the form of volatile and/or nonvolatile memory, such as read only memory (ROM) and random access memory (RAM). A basic input/output system (BIOS), containing the basic routines that help to transfer information between elements within the computer, such as during start-up, is typically stored in the ROM. The RAM typically contains data and/or program modules that are immediately accessible to and/or presently being operated on by the processor.

The computer may also include other removable/non-removable, volatile/nonvolatile computer-storage media, such as (a) a hard disk drive that reads from or writes to non-removable, nonvolatile magnetic media; (b) a magnetic disk drive that reads from or writes to a removable, nonvolatile magnetic disk; and (c) an optical disk drive that reads from or writes to a removable, nonvolatile optical disk such as a CD ROM or other optical medium. The computer-storage medium can be coupled with the system bus by a communication interface, wherein the interface can include, e.g., electrically conductive wires and/or fiber-optic pathways for transmitting digital or optical signals between components. Other removable/non-removable, volatile/nonvolatile computer storage media that can be used in the exemplary operating environment include magnetic tape cassettes, flash memory cards, digital versatile disks, digital video tape, solid state RAM, solid state ROM, and the like.

The drives and their associated computer-storage media provide storage of computer-readable instructions, data structures, program modules and other data for the computer. For example, a hard disk drive inside or external to the computer can store an operating system, application programs, and program data.

The computer can further include a network interface controller in communication with the processor and with an input/output device that communicates with external devices (such as the cameras and a feedback display, projector or speaker in embodiments disclosed herein). The input/output device can include, e.g., input/output ports using electrically conductive wiring or wirelessly via, e.g., a wireless transmitter/receiver electrically connected with the system bus and in wireless communication with a wireless network router with which the external devices are also in communication.

Additional examples consistent with the present teachings are set out in the following numbered clauses:
1. A method for advancing predicted feedback for improved motor training, comprising:
   detecting a trajectory and velocity of an object launched from a launch point by a human via a plurality of time-sequenced images from a plurality of cameras positioned at different angles relative to the launched object;
   projecting, from the images, an extrapolated pathway of the object toward a target;
   evaluating whether the object, when following the extrapolated pathway, is projected to land within or pass through the target; and
   communicating to the human whether the object is projected to land within or pass through the target, wherein the communication occurs after launch yet substantially before the launched object would reach the target or a location at a distance from the launch point that matches the distance from the launch point to the target.
2. The method of clause 1, wherein the object is a ball.
3. The method of clause 2, wherein the ball is a basketball and the target is an area within a basketball hoop.
4. The method of clause 3, wherein a projection of the object landing within or passing through the target is only provided (a) if the object is projected to not bounce off a backboard attached to the hoop or a rim that forms the hoop or (b) if the object is projected to bounce a limited number of times off the backboard or rim.
5. The method of clause 3 or 4, wherein the communication to the human is a visual communication projected on or through a backboard attached to the basketball hoop.
6. The method of any of clauses 1-5, wherein the communication to the human occurs within 200 milliseconds after launch.
7. The method of any of clauses 1-5, wherein the communication to the human occurs within 100 milliseconds after launch.
8. The method of any of clauses 1-7, wherein the communication to the human is visual or auditory.
9. The method of any of clauses 1-8, wherein the communication communicates a miss by providing a vector indication of divergence from the target when the object is projected to land or pass outside the target.
10. The method of any of clauses 1-9, further comprising detecting a spin of the launched object from the images.
11. The method of any of clauses 1-10, further comprising calibrating the camera images of the object with images of calibration patterns and, via that calibration, detecting the position of the object with sub-mm precision.
12. The method of any of clauses 1-11, wherein a first of the cameras captures side images of the launched object from a position horizontal to the launched object, and wherein a second of the cameras captures top-down images of the launched object from a position above the launched object.
13. The method of any of clauses 1-12, further comprising accounting for at least one of the following factors: gravity, air-resistance, and object spin in projecting the extrapolated pathway of the object.
14. A system for advancing predicted feedback for improved motor training, the system comprising:
   a plurality of cameras for generating time-sequenced digital photographs of an object launched from a launch point by a human;
   a computer processor in digital communication with the cameras and configured to receive time-sequenced digital image from the cameras;
   a computer-readable storage device in digital communication with the computer processor and storing software code for:
      a) detecting images of the object in the photographs;
      b) determining a trajectory and velocity of the object from the images;
      c) from the determined trajectory and velocity of the object, projecting whether the object will follow a pathway that will allow the object to land within or pass through a target; and
      d) generating a communication signal to indicate whether the object is projected to land within or pass through the target; and
   a communication device in digital communication with the computer processor and configured to receive the communication signal and to respond to the communication signal by communicating to the human whether the object is projected to land within or pass through the target, wherein the system is configured to communicate to the human whether the object is projected to land within or pass through the target after the human launches the object yet substantially before the object would reach the target or a location at a distance from the launch point that matches the distance from the launch point to the target.
15. The system of clause 14, wherein the object is a ball, and wherein the target is an area within a basketball hoop.
16. The system of clause 15, wherein the communication device is positioned on or behind a backboard from which the basketball hoop extends, and wherein the communication device is configured to generate a visual communication to the human.
17. The system of clause 15 or 16, wherein the software code includes code to generate a communication signal indicating whether the object is projected to land within or pass through the target (a) if the object is projected to not bounce off a backboard attached to the hoop or a rim that forms the hoop or (b) if the object is projected to bounce a limited number of times off the backboard or rim.
18. The system of any of clauses 14-17, wherein the communication device is configured to provide a visual or auditory communication to the human.
19. The system of any of clauses 14-18, wherein the software code includes code for generating a communicating signal providing a vector indicator of divergence from the target when the object is projected to land or pass outside the target.
20. The system of any of clauses 14-19, wherein a first of the cameras is positioned to capture side images of the launched object from a position horizontal to the pathway for the launched object, and wherein a second of the cameras captures top-down images of the launched object from a position above the pathway for the launched object.
21. The system of any of clauses 14-20, wherein the software code includes code that accounts for at least one of the following factors: gravity, air-resistance, and object spin in projecting the extrapolated pathway of the object.

In describing embodiments of the invention, specific terminology is used for the sake of clarity. For the purpose of description, specific terms are intended to at least include technical and functional equivalents that operate in a similar manner to accomplish a similar result. Additionally, in some instances where a particular embodiment of the invention includes a plurality of system elements or method steps, those elements or steps may be replaced with a single element or step. Likewise, a single element or step may be replaced with a plurality of elements or steps that serve the same purpose. Further, where parameters for various properties or other values are specified herein for embodiments of the invention, those parameters or values can be adjusted up or down by 1/100^{th}, 1/50^{th}, 1/20^{th}, 1/10^{th}, ⅕^{th}, ⅓^{rd}, ½, ⅔^{rd}, ¾^{th}, ⅘^{th}, 9/10^{th}, 19/20^{th}, 49/50^{th}, 99/100^{th}, etc. (or up by a factor of 1, 2, 3, 4, 5, 6, 8, 10, 20, 50, 100, etc.), or by rounded-off approximations thereof, unless otherwise specified. Moreover, while this invention has been shown and described with references to particular embodiments thereof, those skilled in the art will understand that various substitutions and alterations in form and details may be made therein without departing from the scope of the invention. Further still, other aspects, functions, and advantages are also within the scope of the invention; and all embodiments of the invention need not necessarily achieve all of the advantages or possess all of the characteristics described above. Additionally, steps, elements and features discussed herein in connection with one embodiment can likewise be used in conjunction with other embodiments. The contents of references, including reference texts, journal articles, patents, patent applications, etc., cited throughout the text are hereby incorporated by reference in their entirety for all purposes; and all appropriate combinations of embodiments, features, characterizations, and methods from these references and the present disclosure may be included in embodiments of this invention. Still further, the components and steps identified in the Background section are integral to this disclosure and can be used in conjunction with or substituted for components and steps described elsewhere in the disclosure within the scope of the invention. In method claims (or where methods are elsewhere recited), where stages are recited in a particular order—with or without sequenced prefacing characters added for ease of reference—the stages are not to be interpreted as being temporally limited to the order in which they are recited unless otherwise specified or implied by the terms and phrasing.

What is claimed is:

1. A method for advancing predicted feedback for improved motor training, comprising:
detecting a trajectory and velocity of an object launched from a launch point by a human via a plurality of time-sequenced images from a plurality of cameras positioned at different angles relative to the launched object;
projecting, from the images, an extrapolated pathway of the object toward a target;
evaluating whether the object, when following the extrapolated pathway, is projected to land within or pass through the target; and
communicating to the human whether the object is projected to land within or pass through the target, wherein the communication occurs after launch yet substantially before the launched object would reach the target or a location at a distance from the launch point that matches the distance from the launch point to the target.

2. The method of claim 1, wherein the object is a ball.

3. The method of claim 2, wherein the ball is a basketball and the target is an area within a basketball hoop.

4. The method of claim 3, wherein a projection of the object landing within or passing through the target is only provided (a) if the object is projected to not bounce off a backboard attached to the hoop or a rim that forms the hoop or (b) if the object is projected to bounce a limited number of times off the backboard or rim.

5. The method of claim 3, wherein the communication to the human is a visual communication projected on or through a backboard attached to the basketball hoop.

6. The method of claim 1, wherein the communication to the human occurs within 200 milliseconds after launch.

7. The method of claim 1, wherein the communication to the human occurs within 100 milliseconds after launch.

8. The method of claim 1, wherein the communication to the human is visual or auditory.

9. The method of claim 1, wherein the communication communicates a miss by providing a vector indication of divergence from the target when the object is projected to land or pass outside the target.

10. The method of claim 1, further comprising detecting a spin of the launched object from the images.

11. The method of claim 1, further comprising calibrating the camera images of the object with images of calibration patterns and, via that calibration, detecting the position of the object with sub-mm precision.

12. The method of claim 1, wherein a first of the cameras captures side images of the launched object from a position horizontal to the launched object, and wherein a second of the cameras captures top-down images of the launched object from a position above the launched object.

13. The method of claim 1, further comprising accounting for at least one of the following factors: gravity, air-resistance, and object spin in projecting the extrapolated pathway of the object.

14. A system for advancing predicted feedback for improved motor training, the system comprising:
a plurality of cameras for generating time-sequenced digital photographs of an object launched from a launch point by a human;
a computer processor in digital communication with the cameras and configured to receive time-sequenced digital image from the cameras;
a computer-readable storage device in digital communication with the computer processor and storing software code for:
a) detecting images of the object in the photographs;
b) determining a trajectory and velocity of the object from the images;
c) from the determined trajectory and velocity of the object, projecting whether the object will follow a pathway that will allow the object to land within or pass through a target; and
d) generating a communication signal to indicate whether the object is projected to land within or pass through the target; and
a communication device in digital communication with the computer processor and configured to receive the communication signal and to respond to the communication signal by communicating to the human whether the object is projected to land within or pass through the target, wherein the system is configured to communicate to the human whether the object is projected to land within or pass through the target after the human launches the object yet substantially before the object would reach the target or a location at a distance from the launch point that matches the distance from the launch point to the target.

15. The system of claim 14, wherein the object is a ball, and wherein the target is an area within a basketball hoop.

16. The system of claim 15, wherein the communication device is positioned on or behind a backboard from which the basketball hoop extends, and wherein the communication device is configured to generate a visual communication to the human.

17. The system of claim 15, wherein the software code includes code to generate a communication signal indicating whether the object is projected to land within or pass through the target (a) if the object is projected to not bounce off a backboard attached to the hoop or a rim that forms the hoop or (b) if the object is projected to bounce a limited number of times off the backboard or rim.

18. The system of claim 14, wherein the communication device is configured to provide a visual or auditory communication to the human.

19. The system of claim 14, wherein the software code includes code for generating a communicating signal providing a vector indicator of divergence from the target when the object is projected to land or pass outside the target.

20. The system of claim 14, wherein a first of the cameras is positioned to capture side images of the launched object from a position horizontal to the pathway for the launched object, and wherein a second of the cameras captures top-down images of the launched object from a position above the pathway for the launched object.

21. The system of claim 14, wherein the software code includes code that accounts for at least one of the following factors: gravity, air-resistance, and object spin in projecting the extrapolated pathway of the object.
